(19) United States
(12) Patent Application Publication
(10) Pub. No.: US 2017/0278128 A1
(43) Pub. Date: Sep. 28, 2017

(54) DYNAMIC ALERTING FOR EXPERIMENTS RAMPING

(71) Applicant: LinkedIn Corporation, Mountain View, CA (US)

(72) Inventors: Ya Xu, Los Altos, CA (US); Kylan Matthew Nieh, Fremont, CA (US); Weitao Duan, Mountain View, CA (US); Bo Liu, Mountain View, CA (US); Luisa Fernanda Hurtado Jaramillo, Sunnyvale, CA (US); Jessica Reel, Pacifica, CA (US)

(21) Appl. No.: 15/081,061

(22) Filed: Mar. 25, 2016

(51) Int. Cl. G06Q 30/02; G06Q 50/00

(52) U.S. Cl. CPC G06Q 30/0243; G06Q 30/0277; G06Q 50/01

(57) ABSTRACT

A machine may be configured to manage alerts related to ramping A/B experiments. For example, the machine identifies an A/B experiment that targets users of a social networking service (SNS). The machine accesses a first value of a metric associated with operation of the SNS. The first value of the metric is generated as a result of a previous execution of the A/B experiment targeting a first segment of users. The machine generates a predicted second value of the metric based on executing a prediction model associated with the A/B experiment. The executing of the prediction model targets a second segment of users that is greater than the first segment. The machine determines that the predicted second value of the metric indicates an inferred negative impact of the A/B experiment on the metric. The machine causes a display of an alert in a user interface displayed on a client device.

### TECHNICAL FIELD

The present application relates generally to data processing systems and, in one specific example, to techniques for managing alerts related to ramping A/B experiments for online content.

### BACKGROUND

The practice of A/B experimentation, also known as “A/B testing” or “split testing,” is a practice for making improvements to webpages and other online content. A/B experimentation typically involves preparing two versions (also known as variants, or treatments) of a piece of online content, such as a webpage, a landing page, an online advertisement, etc., and providing them to separate audiences to determine which variant performs better.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 is a diagram illustrating a targeted segment of members, according to various embodiments;

FIG. 4 illustrates an example portion of a user interface, according to various embodiments;

FIG. 5 is a flowchart illustrating an example method, according to various embodiments;

FIG. 6 is a flowchart illustrating an example method, according to various embodiments;

FIG. 7 is a flowchart illustrating an example method, according to various embodiments;

FIG. 8 is a flowchart illustrating an example method, according to various embodiments;

FIG. 9 is a flowchart illustrating an example method, according to various embodiments;

FIG. 10 illustrates an example portion of a user interface, according to various embodiments;

FIG. 11 illustrates an example mobile device, according to various embodiments; and

FIG. 12 is a diagrammatic representation of a machine in the example form of a computer system within which a set of instructions, for causing the machine to perform any one or more of the methodologies discussed herein, may be executed.

### DETAILED DESCRIPTION

Example methods and systems for managing alerts related to ramping of A/B experiments for online content are described. In the following description, for purposes of explanation, numerous specific details are set forth in order to provide a thorough understanding of example embodiments. It will be evident, however, to one skilled in the art that the embodiments of the present disclosure may be practiced without these specific details.

According to various example embodiments, an A/B testing system enables an experiment administrator or owner to prepare and conduct an A/B experiment of online content among users of an online social networking service (also “SNS”) such as LinkedIn®. The A/B testing system may also predict whether a future ramping of an experiment from a current smaller percentage of targeted users to a future greater percentage of targeted users will negatively impact a metric. An alert threshold value may be associated with the metric, and may indicate the value of the metric at which the A/B experimentation system should alert one or more administrators (e.g., a metric owner, an experiment owner, a metric follower, an experiment follower, etc.) about the potential ramp-up of the experiment negatively affecting the metric. The alerting of one or more administrators interested in an experiment negatively affecting a metric plays an important role especially in monitoring top-tier metrics (e.g., Tier 1 metrics). Top-tier metrics may be high-priority or high-importance metrics for various divisions or groups within an organization.

In some instances, the negative impact on a metric is represented by a positive percentage value (e.g., an increase in “unsubscribe” requests). In other instances, the negative impact on a metric is represented by a negative percentage value (e.g., a decrease in revenue).

In some example embodiments, the A/B testing system identifies an A/B experiment of online content, the A/B experiment being targeted at actual members or potential members of an online social networking service (SNS). The A/B testing system accesses a first value of a metric associated with operation of the online SNS from a record of a database. The first value of the metric is generated as a result of a previous execution of the A/B experiment targeting a first segment of actual members or potential members. The A/B testing system generates a predicted second value of the metric based on executing a prediction model associated with the A/B experiment. The executing of the prediction model targets a second segment of members of potential members that is greater than the first segment. The A/B testing system determines that the predicted second value of the metric indicates an inferred negative impact of the A/B experiment on the metric. The A/B testing system causes a display of an alert message (hereinafter also referred to as “an alert communication” or “an alert”) pertaining to the negative impact of the A/B experiment on the metric in a user interface displayed on a client device.

In some instances, the alert is directed to a metric owner of the metric. The alert may be communicated via a communication (e.g., an email message) transmitted to (or accessed by) the client device associated with the metric owner. Alternately, the alert may be presented in a user interface displayed on the client device (e.g., a mobile phone) of the metric owner, for instance, when the metric owner logs into the client device.

In some example embodiments, the A/B testing system causes a display of the alert in a user interface for reporting experiment results. The user interface for reporting experiment results may be accessed by various users who follow the metric or the experiment (e.g., the metric owner, the experiment owner, an executive of the company, etc.).

The alert may include information pertaining, or otherwise corresponding, to the experiment (e.g., an identifier of the experiment) and the metrics (e.g., identifiers of the metrics) negatively affected by the experiment. The alert may also include one or more of the ramp percentage value to which the experiment will be ramped, the ramp percentage threshold values associated with the negatively impacted metrics at which an alert should be issued, the predicted metric values associated with the negatively impacted metrics, the negative impact values of the experiment on the negatively impacted metrics, and the metrics alert threshold values associated with the negatively impacted metrics at which alerts should be issued. A negative impact value may identify the difference between a first metric value at a lower ramp percentage value and a second metric value at a higher ramp percentage value.

For example, the ramp percentage value to which the experiment is planned to be ramped is 25%, the metric predicted to be negatively impacted by the experiment at ramp percentage value of 25% is metric “123,” the ramp percentage threshold value associated with metric “123” is 12%, the predicted metric value associated with metric “123” is “80%,” the negative impact value of the experiment on metric “123” is “20%,” and the metric alert threshold value associated with metric “123” is “15%.” The metric alert threshold value represents a particular value of the metric for which an alert pertaining to the A/B experiment negatively impacting the metric is issued.

The A/B testing system compares the ramp percentage value (e.g., 25%) and the ramp percentage threshold value associated with metric “123” (e.g., 12%), and determines that the ramp percentage value exceeds the ramp percentage threshold value associated with metric “123” (e.g., 25%>12%). The A/B testing system determines that an alert should be generated for metric “123” based on the determining that the ramp percentage value exceeds the ramp percentage threshold value associated with metric “123.”

The A/B testing system also compares the negative impact value associated with metric “123” (e.g., 20%) and the alert threshold value associated with metric “123” (e.g., 15%), and determines that the negative impact value exceeds the alert threshold value (e.g., 20%>15%). The A/B testing system determines that an alert should be generated for metric “123” based on the determining that the negative impact value associated with metric “123” exceeds the alert threshold value associated with metric “123.”

According to a further example, if the ramp percentage value does not exceed the ramp percentage threshold value associated with a metric, the A/B testing system does not issue an alert message. Also, if the negative impact value associated with the metric does not exceed the alert threshold value associated with the metric, the A/B testing system does not issue an alert message.

In some example embodiments, based on receiving an alert, a metric owner may contact an experiment owner of the experiment that is predicted to negatively impact the metric as a result of a future ramping of the experiment. The metric owner may request the generation of a communication, by a client device associated with the metric owner, for the experiment owner to approve the ramp-up, to request a delay of the ramp-up, to negotiate a different ramp-up, etc. Accordingly, the A/B testing system may facilitate better monitoring of the impact of experiments on various metrics (e.g., operational metrics, system-related metrics, etc.) and better communication pertaining to ramping of experiments that may impact the various metrics.

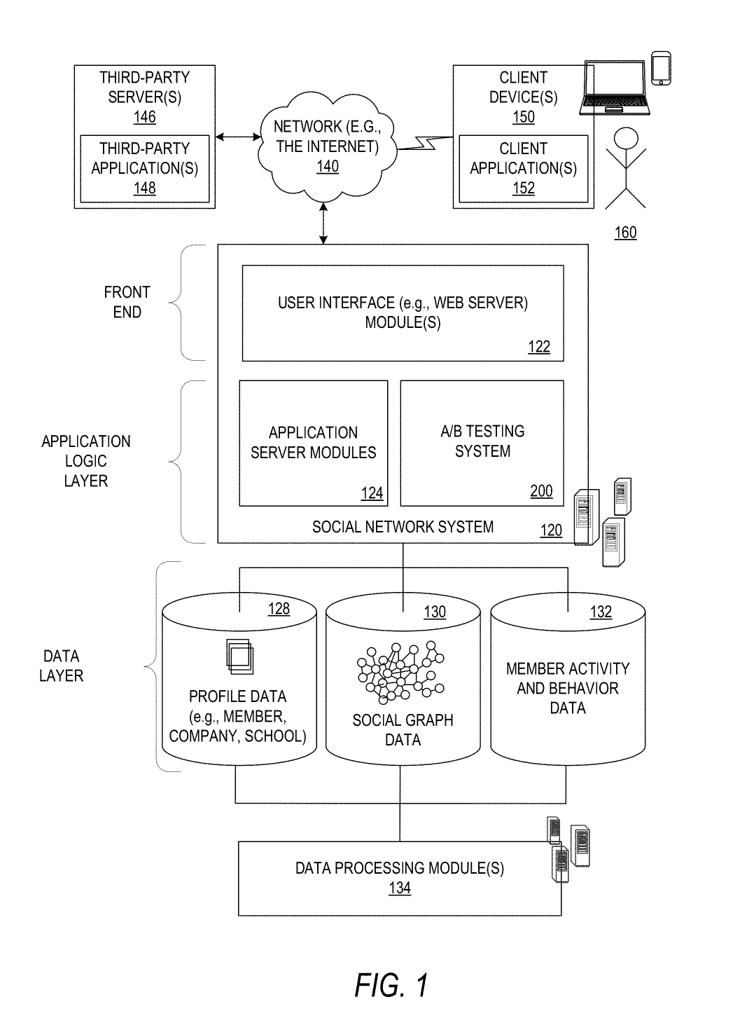

FIG. 1 is a block diagram illustrating various components or functional modules of a social network service such as the social network system 120, consistent with some embodiments. As shown in FIG. 1, the front end consists of a user interface module (e.g., a web server) 122, which receives requests from various client computing devices including one or more client device(s) 150, and communicates appropriate responses to the requesting client devices. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social network system 120. Each of the client devices 150 may comprise a computing device that includes at least a display and communication capabilities with the network 140 to access the social network system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social network system 120 via the client device(s) 150. The user(s) 160 may not be part of the networked environment, but may be associated with client device(s) 150.

The application logic layer includes various application server modules 124, which, in conjunction with the user interface module(s) 122, generates various user interfaces (e.g., web pages) with data retrieved from various data sources in the data layer. With some embodiments, individual application server modules 124 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 124. Similarly, a variety of other applications or services that are made available to members of the social network service will be embodied in their own application server modules 124.

As shown in FIG. 1, the data layer includes several databases, such as a database 128 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 128. Similarly, when a representative of an organization initially registers the organization with the social network service, the representative may be prompted to provide certain information about the organization. This information may be stored, for example, in the database with reference number 128, or another database. With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph database, shown in FIG. 1 with reference number 130.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored or tracked, and information concerning the member's activities and behavior may be stored, for example, as indicated in FIG. 1 in the database with reference number 132.

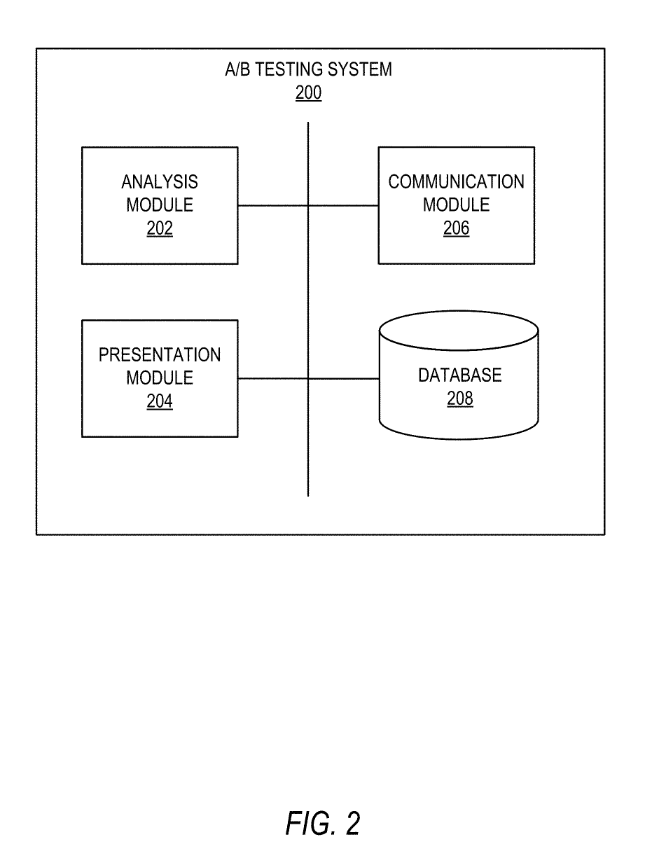

With some embodiments, the social network system 120 includes what is generally referred to herein as an A/B testing system 200. The A/B testing system 200 is described in more detail below in conjunction with FIG. 2.

Additionally, a third-party application(s) 148, executing on a third-party server(s) 146, is shown as being communicatively coupled to the social network system 120 and the client device(s) 150. The third-party server(s) 146 may support one or more features or functions on a website hosted by the third party.

Although not shown, with some embodiments, the social network system 120 provides an application programming interface (API) module via which third-party applications 148 can access various services and data provided by the social network service. For example, using an API, a third-party application 148 may provide a user interface and logic that enables an authorized representative of an organization to publish messages from a third-party application 148 to a content hosting platform of the social network service that facilitates presentation of activity or content streams maintained and presented by the social network service. Such third-party applications 148 may be browser-based applications, or may be operating system-specific. In particular, some third-party applications 148 may reside and execute on one or more mobile devices (e.g., phone, or tablet computing devices) having a mobile operating system.

Further, as shown in FIG. 1, a data processing module 134 may be used with a variety of applications, services, and features of the social network system 120. The data processing module 134 may periodically access one or more of the databases 128, 130, or 132, process (e.g., execute batch process jobs to analyze or mine) profile data, social graph data, or member activity and behavior data, and generate analysis results based on the analysis of the respective data. The data processing module 134 may operate offline. According to some example embodiments, the data processing module 134 operates as part of the social network system 120. Consistent with other example embodiments, the data processing module 134 operates in a separate system external to the social network system 120. In some example embodiments, the data processing module 134 may include multiple servers of a large-scale distributed storage and processing framework, such as Hadoop servers, for processing large data sets. The data processing module 134 may process data in real time, according to a schedule, automatically, or on demand.

According to various example embodiments, an A/B experimentation system, such as A/B testing system 200, is configured to enable a user of the A/B testing system 200 to prepare and conduct an A/B experiment of online content among users (e.g., actual members or potential members/guests) of an online social networking service (also “SNS”) such as LinkedIn®. The A/B experimentation system may display a targeting user interface allowing the user to specify targeting criteria statements that reference members of an online social networking service based on their member attributes (e.g., their member profile attributes displayed on their member profile page, or other member attributes that may be maintained by an online social networking service that may not be displayed on member profile pages). In some embodiments, the member attribute is any of location, role, industry, language, current job, employer, experience, skills, education, school, endorsements of skills, seniority level, company size, connections, connection count, account level, name, username, social media handle, email address, phone number, fax number, resume information, title, activities, group membership, images, photos, preferences, news, status, links or URLs on a profile page, and so forth. For example, the user can enter targeting criteria such as “role is sales”, “industry is technology”, “connection count>500”, “account is premium”, and so on, and the system will identify a targeted segment of members of an online social network service satisfying all of these criteria. The system can then target all of these users in the targeted segment for online A/B experimentation.

Once the segment of users to be targeted has been defined, the system allows the user to define different variants for the experiment, such as by uploading files, images, HTML code, webpages, data, etc., associated with each variant and providing a name for each variant. One of the variants may correspond to an existing feature or variant, also referred to as a “control” variant, while the other may correspond to a new feature being tested, also referred to as a “treatment”. For example, if the A/B experiment is testing a user response (e.g., click through rate or CTR) for a button on a homepage of an online social networking service, the different variants may correspond to different types of buttons such as a blue circle button, a blue square button with rounded corners, and so on. Thus, the user may upload an image file of the appropriate buttons and/or code (e.g., HTML code) associated with different versions of the webpage containing the different variants.

Thereafter, the system may display a user interface allowing the user to allocate different variants to different percentages of the targeted segment of users. For example, the user may allocate variant A to 10% of the targeted segment of members, variant B to 20% of the targeted segment of members, and a control variant to the remaining 70% of the targeted segment of members, via an intuitive and easy to use user interface. The user may also change the allocation criteria by, for example, modifying the aforementioned percentages and variants. Moreover, the user may instruct the system to execute the A/B experiment, and the system will identify the appropriate percentages of the targeted segment of members and expose them to the appropriate variants.

In some example embodiments, the A/B testing system 200 determines whether a future ramping of an experiment to a greater percentage of targeted users (e.g., actual members or potential members/guests of the SNS) will negatively impact a metric. An alert threshold value may be associated with the metric, and may indicate the value of the metric at which the A/B testing system 200 should alert one or more administrators (e.g., a metric owner, an experiment owner, a metric follower, an experiment follower, etc.) about the potential ramp-up of the experiment negatively affecting the metric. The alerting of one or more administrators interested in an experiment negatively affecting a metric plays an important role especially in monitoring top-tier metrics.

The A/B testing system 200 collects data for a number of metrics (e.g., click-throughs, unsubscribe requests, etc.), and determines which metrics are being affected by which experiments. For example, it is known that before experiment XYZ was executed, metric “123” had a value of 100%. After A/B testing system 200 applies experiment XYZ to 5% of the targeted group of users (e.g., the ramp value is equal to 5%), A/B testing system 200 determines that the value of metric “123” is 90%. Based on this data pertaining to metric “123,” the A/B testing system 200 determines that the negative impact value of experiment XYZ on metric “123” at ramp value of 5% is “10%”.

Further, based on a prediction model for predicting the impact of ramping up an experiment and the historical ramp data for the metric, the A/B testing system 200 determines that if the experiment is ramped to 25% (e.g., the ramp value is increased from 5% of users in the treatment variant to 25% of users in the treatment variant), the predicted metric value will be “85%,” and the predicted negative impact value associated with the new ramp value of 25% is going to be “15%”.

Next, the A/B testing system 200 may compare the predicted negative impact value (e.g., “15%”) with an alert threshold value associated with the metric (e.g., “12%”), and may determine that the predicted negative impact value exceeds the alert threshold value associated with the metric. The A/B testing system 200 issues an alert to the one or more administrators interested in metric, the alert notifying the one or more administrators that an experiment that is about to be ramped up exceeds the threshold value associated with the metric. In response to the alert, the one or more administrators may communicate among themselves with respect to the experiment about to be ramped up.

Turning now to FIG. 2, an A/B testing system 200 includes an analysis module 202, a presentation module 204, a communication module 206, and a database 206. In some instances, the database 208 is external to the A/B testing system 200.

The modules of the A/B testing system 200 may be implemented on or executed by a single device, such as an A/B testing device, or on separate devices interconnected via a network. The aforementioned A/B testing device may be, for example, one or more client machines or application servers. The operation of each of the aforementioned modules of the A/B testing system 200 will now be described in greater detail in conjunction with the various figures.

To run an experiment, the A/B testing system 200 allows a user to create a testKey, which is a unique identifier that represents the concept or the feature to be tested. The A/B testing system 200 then creates an actual experiment as an instantiation of the testKey, and there may be multiple experiments associated with a testKey. Such hierarchical structure makes it easy to manage experiments at various stages of the testing process. For example, suppose the user wants to investigate the benefits of adding a background image. The user may begin by diverting only 1% of US users to the treatment, then increasing the allocation to 50% and eventually expanding to users outside of the US market. Even though the feature being tested remains the same throughout the ramping process, it requires different experiment instances as the traffic allocations and targeting changes. In other words, an experiment acts as a realization of the testKey, and only one experiment per testKey can be active at a time.

Every experiment is comprised of one or more segments, with each segment identifying a subpopulation to experiment on. For example, a user may set up an experiment with a “whitelist” segment containing only the team members developing the product, an “internal” segment consisting of all company employees and additional segments targeting external users. Because each segment defines its own traffic allocation, the treatment can be ramped to 100% in the whitelist segment, while still running at 1% in the external segments. Note that segment ordering matters because members are only considered as part of the first eligible segment. After the experimenters input their design through an intuitive User Interface, all the information is then concisely stored by the A/B testing system 200 in a DSL (Domain Specific Language). For example, the line below indicates a single segment experiment targeting English-speaking users in the US where 10% of them are in the treatment variant while the rest in control.

(ab(=(locale)“en_US”)[treatment 10% control 90%])

In some embodiments, the A/B testing system 200 may log data every time a treatment for an experiment is called, and not simply for every request to a webpage on which the treatment might be displayed. This not only reduces the logs footprint, but also enables the A/B testing system 200 to perform triggered analysis, where only users who were actually impacted by the experiment are included in the A/B test analysis. For example, LinkedIn.com could have 20 million daily users, but only 2 million of them visited the “jobs” page where the experiment is actually on, and even fewer viewed the portion of the “jobs” page where the experiment treatment is located. Without such trigger information, it is difficult to isolate the real impact of the experiment from the noise, especially for experiments with low trigger rates.

Conventional A/B testing reports may not accurately represent the global lift that will occur when the winning treatment is ramped to 100% of the targeted segment (holding everything else constant). The reason is two-fold. Firstly, most experiments only target a subset of the entire user population (e.g., US users using an English language interface, as specified by the command “interface-locale=en_US”). Secondly, most experiments only trigger for a subset of their targeted population (e.g., members who actually visit a profile page where an experiment resides). In other words, triggered analysis only provides evaluation of the local impact, not the global impact of an experiment.

According to various example embodiments, the A/B testing system 200 is configured to compute a Site-wide Impact value, defined as the percentage delta between two scenarios or “parallel universes”: one with treatment applied to only targeted users and control to the rest, the other with control applied to all. Put another way, the site-wide impact is the x % delta if a treatment is ramped to 100% of its targeting segment. With site-wide impact provided for all experiments, users are able to compare results across experiments regardless of their targeting and triggering conditions. Moreover, Site-wide Impact from multiple segments of the same experiment can be added up to give an assessment of the total impact.

For most metrics that are additive across days, the A/B testing system 200 may simply keep a daily counter of the global total and add them up for any arbitrary date range. However, there are metrics, such as the number of unique visitors, which are not additive across days. Instead of computing the global total for all date ranges that the A/B testing system 200 generates reports for, the A/B testing system 200 estimates them based on the daily totals, saving more than 99% of the computation cost without sacrificing a great deal of accuracy.

In some embodiments, the average number of clicks is utilized as an example metric to show how the A/B testing system 200 computes Site-wide Impact. Let Xₜ, X_{c}, X_{seg} and X_{global} denote the total number of clicks in the treatment group, the control group, the whole segment (including the treatment, the control and potentially other variants) and globally across the site, respectively. Similarly, let nₜ, n_{c}, n_{seg} and n_{global} tem denote the sample sizes for each of the four groups mentioned above.

The total number of clicks in the treatment (control) universe can be estimated as:

$${X}_{tUniverse} = \frac{{X}_{t}}{{n}_{t}} {n}_{seg} + ( {X}_{global} - {X}_{seg} )$$

$${X}_{cUniverse} = \frac{{X}_{c}}{{n}_{c}} {n}_{seg} + ( {X}_{global} - {X}_{seg} )$$

Then the Site-wide Impact is computed as

$$\begin{matrix}SWI = ( \frac{{X}_{tUniverse}}{{n}_{tUniverse}} - \frac{{X}_{cUniverse}}{{n}_{cUniverse}} ) / \frac{{X}_{cUniverse}}{{n}_{cUniverse}} \\ = ( \frac{\frac{{X}_{t}}{{n}_{t}} - \frac{{X}_{c}}{{n}_{c}}}{\frac{{X}_{c}}{{n}_{c}}} ) \times ( \frac{\frac{{X}_{c}}{{n}_{c}} {n}_{seg}}{\frac{{X}_{c}}{{n}_{c}} {n}_{seg} + {X}_{global} - {X}_{seg}} ) \\ = Δ \times α\end{matrix}$$

which indicates that the Site-wide Impact is essentially the local impact Δ scaled by a factor of α. For metrics such as average number of clicks, Xglobal for any arbitrary date range can be computed by summing over clicks from corresponding single days. However, for metrics such as average number of unique visitors, de-duplication is necessary across days. To avoid having to compute a for all date ranges that the A/B testing system 200 generate reports for, the A/B testing system 200 estimates cross-day a by averaging the single-day a's. Another group of metrics include a ratio of two metrics. One example is Click-Through-Rate, which equals Clicks over Impressions. The derivation of Site-wide Impact for ratio metrics is similar, with the sample size replaced by the denominator metric.

In some example embodiments, the analysis module 202 receives a user specification of an online A/B experiment of online content being targeted at a segment of members of an online social networking service, a treatment variant of the A/B experiment being applied to (or triggered by) a subset of the segment of members. The analysis module 202 accesses a value of a metric associated with application of the treatment variant of the A/B experiment to the subset of the segment of members in operation 501. The analysis module 202 calculates a site-wide impact value for the A/B experiment that is associated with the metric. The site-wide impact value indicates a predicted percentage change in the value of the metric responsive to application of the treatment variant to 100% of the targeted segment of members, in comparison to application of the control variant to 100% of the targeted segment of members.

The presentation module 204 displays, via a user interface displayed on a client device, the site-wide impact value.

In various example embodiments, the analysis module 202 identifies an A/B experiment of online content. The A/B experiment is targeted at actual members or potential members of an online social networking service (SNS). In some instances, the identifying of the A/B experiment includes determining that the A/B experiment is an experiment to be ramped to a greater percentage of targeted users (e.g., actual members or potential members of the SNS).

The analysis module 202 accesses a first value of a metric associated with operation of the online SNS. The first value of the metric is generated as a result of a previous execution of the A/B experiment targeting a first segment of actual members or potential members. In some instances, the accessing of the first value of the metric includes selecting, from one or more values of one or more metrics generated as a result of the previous execution of the A/B experiment, the first value of the metric based on an indicator of a negative impact of the A/B experiment on the first value of the metric.

The analysis module 202 generates a predicted second value of the metric based on executing a prediction model associated with the A/B experiment. The prediction model, in some example embodiments, takes as input historical data pertaining to previous executions of the A/B experiment (e.g., data pertaining to previous ramp-ups of the A/B experiment). The executing of the prediction model targets a second segment of members of potential members that is greater than the first segment. In some instances, the second segment of members of potential members is represented by a ramp percentage value associated with a future execution of the A/B experiment.

The analysis module 202 determines that the predicted second value of the metric indicates an inferred negative impact of the A/B experiment on the metric.

The presentation module 204 causes a display of an alert pertaining to the negative impact of the A/B experiment on the metric in a user interface displayed on a client device. The presentation module 204 may display the alert based on (e.g., in response to) the analysis module 202 determining that the predicted second value of the metric indicates the inferred negative impact of the A/B experiment on the metric.

To perform one or more of its functionalities, the A/B testing system 200 may communicate with one or more other systems. For example, an integration engine may integrate the A/B testing system 200 with one or more email server(s), web server(s), one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 208 (e.g., database 128, 130, or 132).

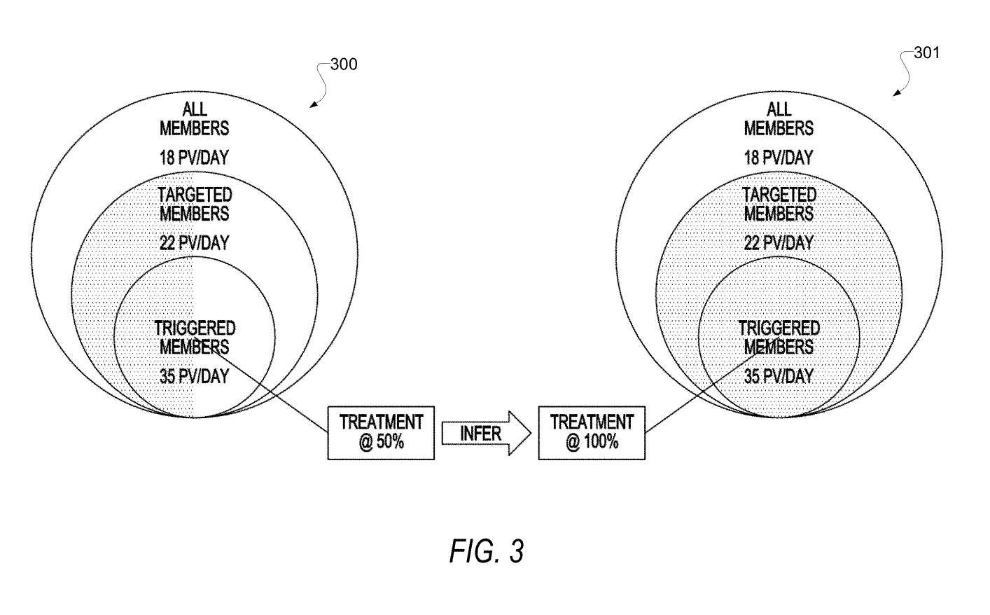

As illustrated in FIG. 3, in portion 300 an experiment may be targeted at a targeted segment of members or “targeted members”, who are a subpopulation of “all members” of an online social networking service. Moreover, the experiment will only be triggered for triggered members”, which is the subpopulation of the “targeted members” who are actually impacted by the experiment (e.g., that actually interact with the treatment). In portion 300, the treatment is only ramped to 50% of the targeted segment of members, and various metrics about the improvement of the treatment may be obtained as a result (e.g., a treatment page view metric that may be compared to a control page view metric). As illustrated in portion 301, the techniques described herein may be utilized to infer the improvement of the treatment variant if the treatment would be ramped to 100% of the targeted segment. More specifically, the AB testing system 200 may infer the percentage improvement if the treatment variant is applied to 100% of the targeted segment, in comparison to the control variant being applied to 100% of the targeted segment.

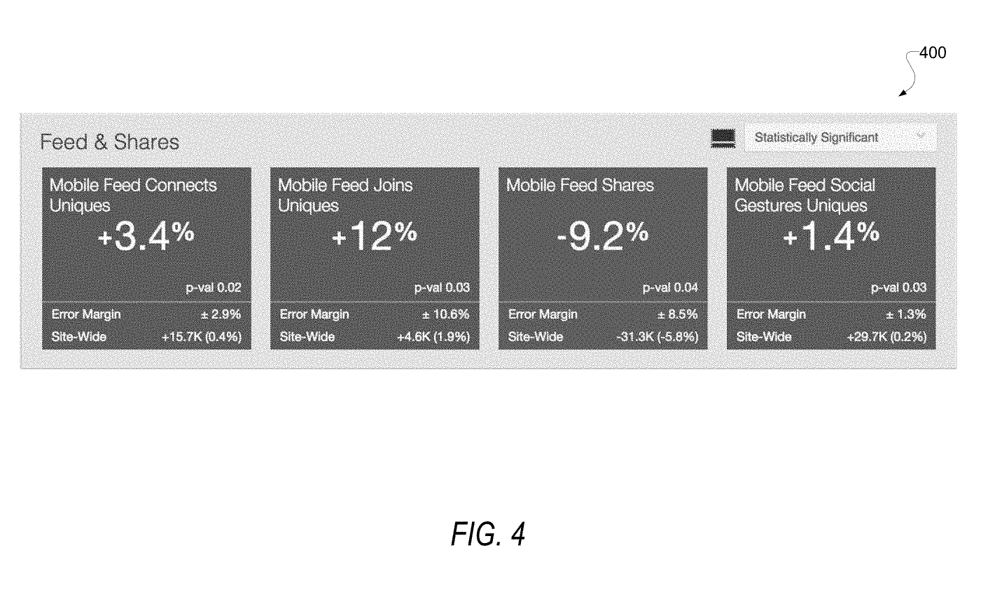

For example, FIG. 4 illustrates an example of user interface 400 that displays the % delta increase in the values of various metrics during an A/B experiment. Moreover, the user interface 400 indicates the site-wide impact of each metric, including a % delta increase/decrease.

In some example embodiments, a selection (e.g., by a user) of the “Statistically Significant” drop-down bar illustrated in FIG. 4 shows which comparisons (e.g., variant 1 vs. variant 4, or variant 6 vs. variant 12) are statistically significant.

In certain example embodiments, the user interface 400 provides an indication of the Absolute Site-wide Impact value, the percentage Site-wide Impact value, or both. For example, as illustrated in FIG. 4, for Mobile Feed Connects Uniques, the Absolute Site-wide Impact value is “+15.7K,” and the percentage Site-wide Impact value is “0.4%.”

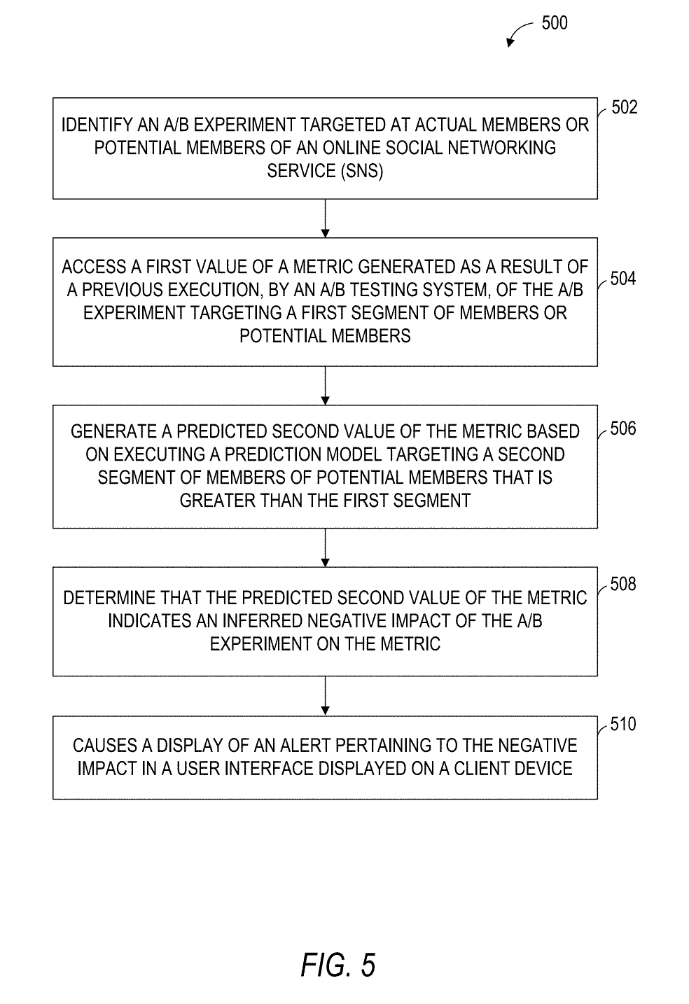

FIG. 5 is a flowchart illustrating an example method 500, consistent with various embodiments described herein. The method 500 may be performed at least in part by, for example, the A/B testing system 200 illustrated in FIG. 2 (or an apparatus having similar modules, such as one or more client machines or application servers).

At operation 502, the analysis module 202 identifies an A/B experiment of online content. The A/B experiment is targeted at actual members or potential members of an online social networking service (SNS). In some instances, the identifying of the A/B experiment includes determining that the A/B experiment is an experiment to be ramped to a greater percentage of targeted users (e.g., actual members or potential members of the SNS).

At operation 504, the analysis module 202 accesses a first value of a metric associated with operation of the online SNS from a record of database (e.g., database 208) associated with an A/B testing system (e.g., the A/B testing system 200). The first value of the metric is generated as a result of a previous execution of the A/B experiment targeting a first segment of actual members or potential members. In some example embodiments, the accessing of the first value of the metric includes selecting, from one or more values of one or more metrics generated as a result of the previous execution of the A/B experiment, the first value of the metric based on an indicator of a negative impact of the A/B experiment on the first value of the metric. In some instances, the indicator of the negative impact of the A/B experiment on the first value of the metric includes a negative percentage value (e.g., a decrease in the percentage of click-throughs) associated with the metric as a result of the previous execution of the A/B experiment. In certain instances, the indicator of the negative impact of the A/B experiment on the first value of the metric includes a positive percentage value experiment (e.g., an increase in the percentage of unsubscribe requests) associated with the metric as a result of the previous execution of the A/B.

At operation 506, the analysis module 202 generates, using one or more hardware processors associated with the A/B testing system 200, a predicted second value of the metric based on executing a prediction model associated with the A/B experiment. The prediction model, in some example embodiments, takes as input historical data pertaining to previous executions of the A/B experiment (e.g., data pertaining to previous ramp-ups of the A/B experiment). The executing of the prediction model targets a second segment of members of potential members that is greater than the first segment. The executing of the prediction model may be performed by one or more modules of the A/B testing system 200. In some example embodiments, the second segment of members of potential members is represented by a ramp percentage value associated with a future execution of the A/B experiment.

At operation 508, the analysis module 202 determines that the predicted second value of the metric indicates an inferred negative impact of the A/B experiment on the metric.

At operation 510, the presentation module 204 causes a display of an alert pertaining to the negative impact of the A/B experiment on the metric in a user interface displayed on a client device. The presentation module 204 may display the alert based on (e.g., in response to) the analysis module 202 determining that the predicted second value of the metric indicates the inferred negative impact of the A/B experiment on the metric.

It is contemplated that the operations of method 500 may incorporate any of the other features disclosed herein. Various operations in the method 500 may be omitted or rearranged, as necessary.

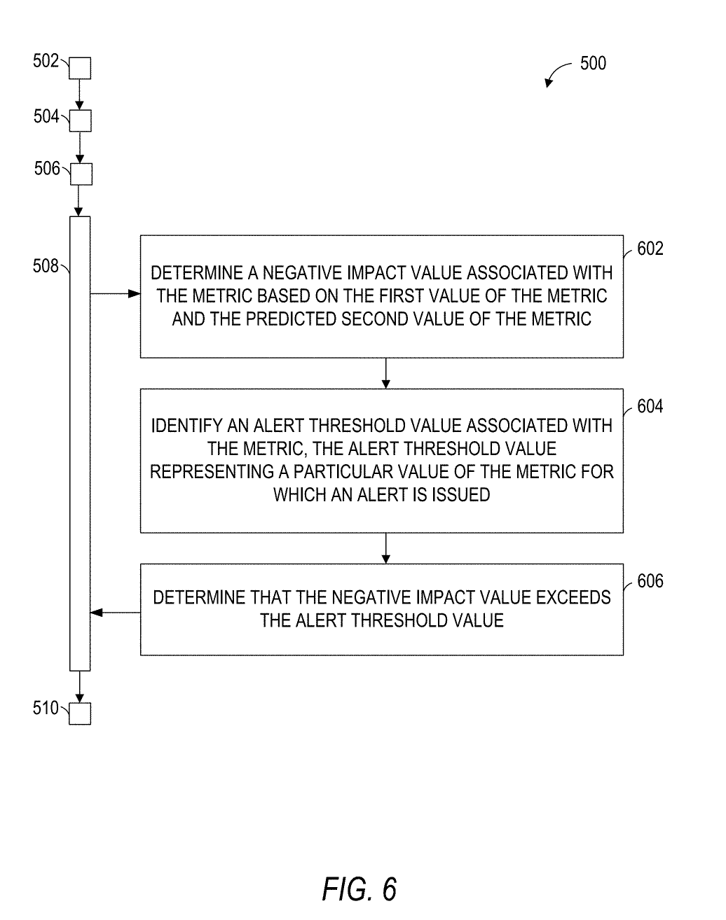

As shown in FIG. 6, method 500 may include one or more of operations 602, 604, or 606, according to some example embodiments. Operation 602 may be performed as part (e.g., a precursor task, a subroutine, or a portion) of operation 508, in which the analysis module 202 determines that the predicted second value of the metric indicates an inferred negative impact of the A/B experiment on the metric.

At operation 602, the analysis module 202 determines a negative impact value associated with the metric based on the first value of the metric and the predicted second value of the metric. In some example embodiments, the determining of the negative impact value associated with the metric includes subtracting the first value of the metric from the predicted second value of the metric. The negative impact value may be assigned the resulting difference between the predicted second value of the metric and the first value of the metric.

Operation 604 may be performed after operation 602. At operation 604, the analysis module 202 identifies an alert threshold value associated with the metric. The alert threshold value represents a particular value of the metric for which an alert pertaining to the A/B experiment negatively impacting the metric is issued.

Operation 606 may be performed after operation 604. At operation 604, the analysis module 202 determines that the negative impact value associated with the metric exceeds the alert threshold value associated with the metric based on a comparison of the negative impact value and the alert threshold value.

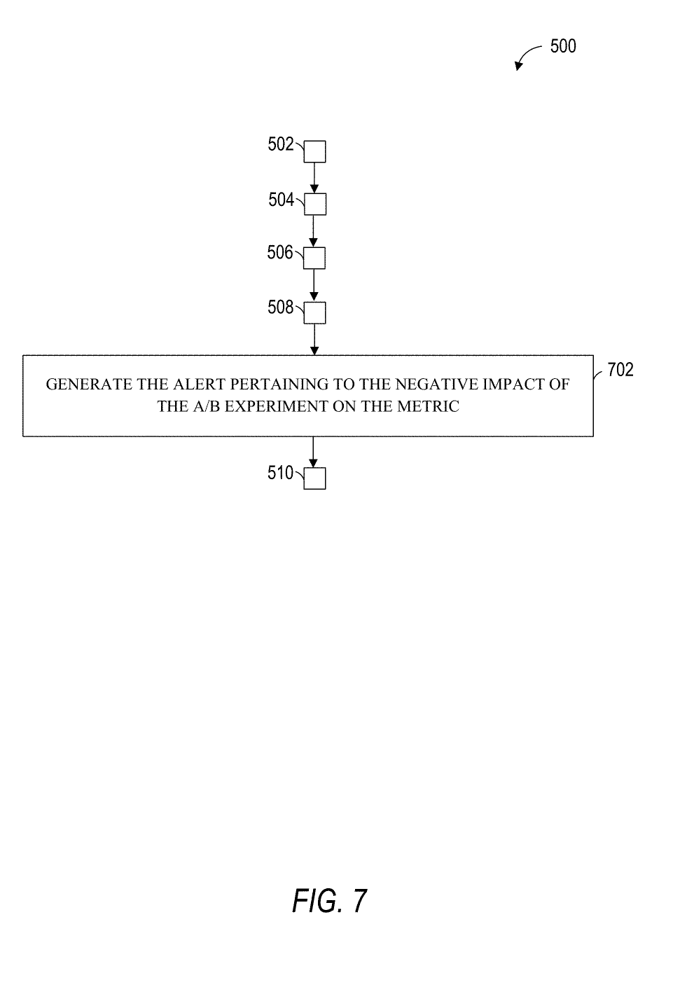

As shown in FIG. 7, method 500 may include operation 702, according to some example embodiments. Operation 702 may be performed after operation 508, in which the analysis module 202 determines that the predicted second value of the metric indicates an inferred negative impact of the A/B experiment on the metric.

At operation 702, the analysis module 202 generates the alert pertaining to the negative impact of the A/B experiment on the metric. The generating of the alert may be based on the determining that the predicted second value of the metric indicates the inferred negative impact of the A/B experiment on the metric.

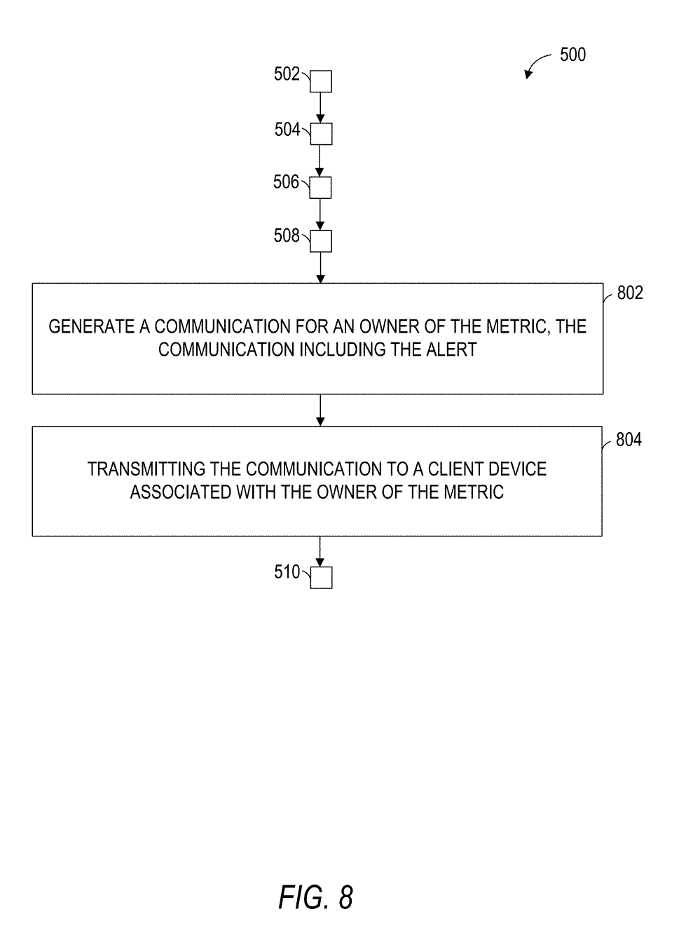

As shown in FIG. 8, method 500 may include one or more of the operations 802 or 804, according to some example embodiments. Operation 802 may be performed after operation 508, in which the analysis module 202 determines that the predicted second value of the metric indicates an inferred negative impact of the A/B experiment on the metric.

At operation 802, the communication module 206 generates a communication (e.g., an email message) for an owner of the metric. The communication includes the alert pertaining to the negative impact of the A/B experiment on the metric.

At operation 804, the communication module 206 transmits the communication to a client device associated with the owner of the metric.

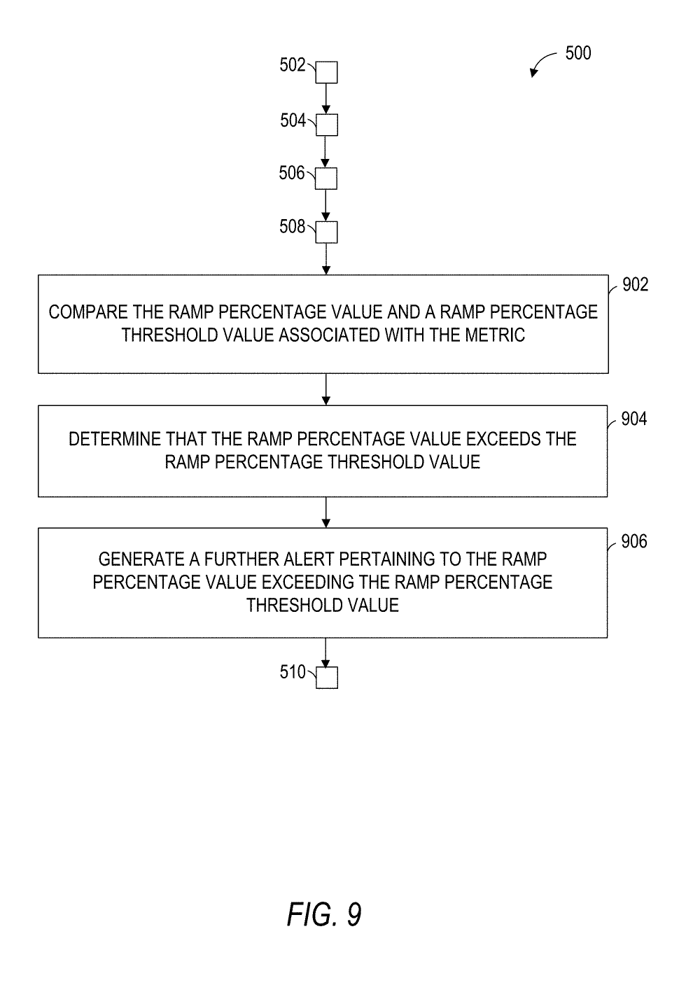

As shown in FIG. 9, method 500 may include one or more of the operations 902, 904, or 906, according to some example embodiments. Operation 902 may be performed after operation 508, in which the analysis module 202 determines that the predicted second value of the metric indicates an inferred negative impact of the A/B experiment on the metric.

At operation 902, the analysis module 202 compares the ramp percentage value and a ramp percentage threshold value associated with the metric.

At operation 904, the analysis module 202 determines that the ramp percentage value exceeds the ramp percentage threshold value.

At operation 906, the analysis module 202 generates a further alert pertaining to the ramp percentage value exceeding the ramp percentage threshold value. In some example embodiments, the presentation module 204 causes the display of the further alert in the user interface displayed on the client device. In certain example embodiments, the communication module 206 generates a further communication for an owner of the metric. The further communication includes the further alert, and transmits the further communication to a client device associated with the owner of the metric.

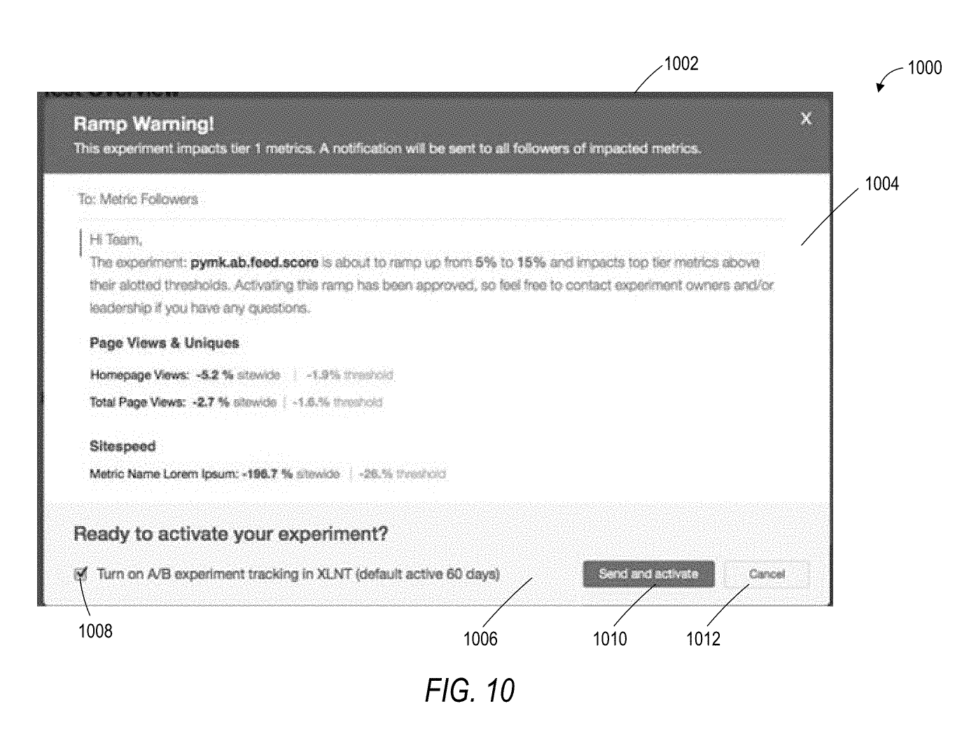

FIG. 10 illustrates an example representation 1000 of an alert generated by the A/B testing system 200. The A/B testing system 200 may cause the display of the alert in a user interface of a client device associated with a user (e.g., a user who subscribes to or follows a particular metric, such as “homepage views” or “total page views,” a metric owner, an experiment owner, etc.), may transmit a communication (e.g., an email message) including the alert to the client device associated with the user, or both.

As illustrated in FIG. 10, the example representation 1000 of the alert 1002 generated by the A/B testing system 200 includes a message 1004 addressed to metric followers (e.g., users who subscribe to follow metrics “homepage views,” “total page views,” or “Lorem Ipsum”). The content of the message identifies an experiment (e.g., the experiment with the identifier “pymk.ab.feed.score”) that is about to ramp up from 5% of the target users (e.g., actual members of the SNS, potential members of the SNS, guests of or visitors to the SNS) to 15% of the target users. The content of the message also indicates that the experiment impacts one or more top tier metrics above the thresholds values associated with the one or more top tier metrics. The content of the message also notifies the user receiving the alert 1002 that the ramp to 15% has been approved, and that the receiver of the user receiving the alert 1002 may contact the experiment owner(s) with any questions.

In addition, the content of the message lists the top tier metrics negatively impacted by the experiment, the site-wide impact values associated with the respective top tier metrics, and the threshold values associated with the respective top tier metrics at which alerts should be issued.

In some example embodiments, if the alert 1002 is sent to an experiment owner, the alert 1002 may also include field 1006 which asks the experiment owner whether the experiment owner is ready to activate the experiment. The field 1006 also includes a selection box 1008 for facilitating the activation (e.g., turning on) of A/B experiment tracking, button 1010 for sending the alert 1002 to the metric followers and activating the experiment, and button 1012 for cancelling the experiment.

While examples herein refer to metrics such as a number of page views associated with the homepage and a number of total page views, such metrics are merely exemplary, and the techniques described herein are applicable to any type of metric that may be measure during an online AB experiment, such as profile completeness score, revenue, average page load time, etc.

### Example Mobile Device

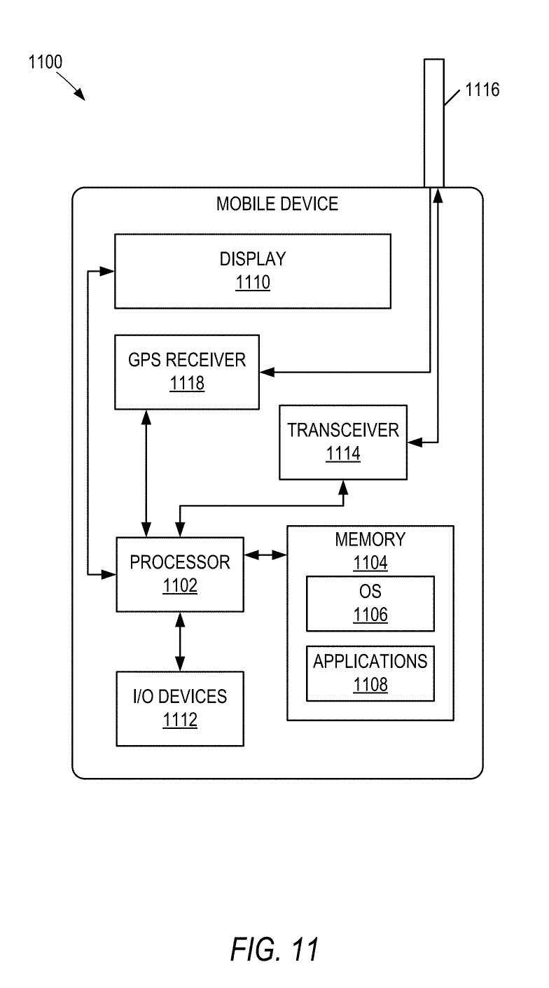

FIG. 11 is a block diagram illustrating the mobile device 1100, according to an example embodiment. The mobile device may correspond to, for example, one or more client machines or application servers. One or more of the modules of the system 200 illustrated in FIG. 2 may be implemented on or executed by the mobile device 1100. The mobile device 1100 may include a processor 1102. The processor 1102 may be any of a variety of different types of commercially available processors 1102 suitable for mobile devices 1100 (for example, an XScale architecture microprocessor, a microprocessor without interlocked pipeline stages (MIPS) architecture processor, or another type of processor 1102). A memory 1104, such as a random access memory (RAM), a flash memory, or other type of memory, is typically accessible to the processor 1102. The memory 1104 may be adapted to store an operating system (OS) 1106, as well as application programs 1108, such as a mobile location enabled application that may provide LBSs to a user. The processor 1102 may be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 may be coupled to a transceiver 1114 that interfaces with an antenna 1116. The transceiver 1114 may be configured to both transmit and receive cellular network signals, wireless data signals, or other types of signals via the antenna 1116, depending on the nature of the mobile device 1100. Further, in some configurations, a GPS receiver 1118 may also make use of the antenna 1116 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

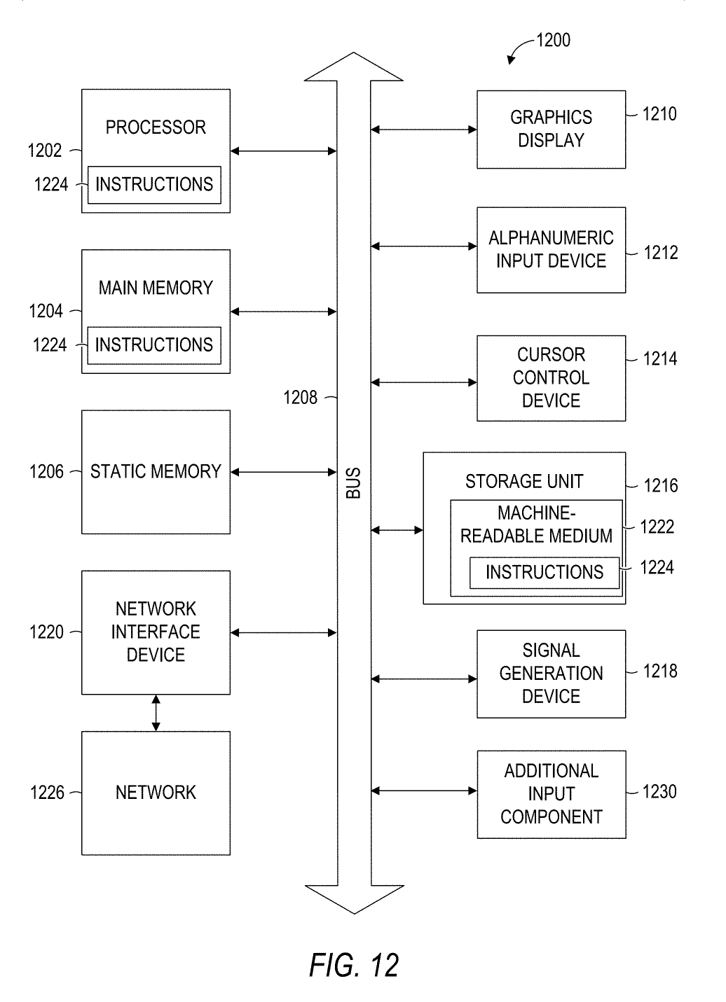

FIG. 12 is a block diagram illustrating components of a machine 1200, according to some example embodiments, able to read instructions 1224 from a machine-readable medium 1222 (e.g., a non-transitory machine-readable medium, a machine-readable storage medium, a computer-readable storage medium, or any suitable combination thereof) and perform any one or more of the methodologies discussed herein, in whole or in part. Specifically, FIG. 12 shows the machine 1200 in the example form of a computer system (e.g., a computer) within which the instructions 1224 (e.g., software, a program, an application, an applet, an app, or other executable code) for causing the machine 1200 to perform any one or more of the methodologies discussed herein may be executed, in whole or in part.

In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include any collection of machines that individually or jointly execute the instructions 1224 to perform all or part of any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The processor 1202 may contain microcircuits that are configurable, temporarily or permanently, by some or all of the instructions 1224 such that the processor 1202 is configurable to perform any one or more of the methodologies described herein, in whole or in part. For example, a set of one or more microcircuits of the processor 1202 may be configurable to execute one or more modules (e.g., software modules) described herein.

The machine 1200 may further include a graphics display 1210 (e.g., a plasma display panel (PDP), a light emitting diode (LED) display, a liquid crystal display (LCD), a projector, a cathode ray tube (CRT), or any other display capable of displaying graphics or video). The machine 1200 may also include an alphanumeric input device 1212 (e.g., a keyboard or keypad), a cursor control device 1214 (e.g., a mouse, a touchpad, a trackball, a joystick, a motion sensor, an eye tracking device, or other pointing instrument), a storage unit 1216, an audio generation device 1218 (e.g., a sound card, an amplifier, a speaker, a headphone jack, or any suitable combination thereof), and a network interface device 1220.

The storage unit 1216 includes the machine-readable medium 1222 (e.g., a tangible and non-transitory machine-readable storage medium) on which are stored the instructions 1224 embodying any one or more of the methodologies or functions described herein. The instructions 1224 may also reside, completely or at least partially, within the main memory 1204, within the processor 1202 (e.g., within the processor's cache memory), or both, before or during execution thereof by the machine 1200. Accordingly, the main memory 1204 and the processor 1202 may be considered machine-readable media (e.g., tangible and non-transitory machine-readable media). The instructions 1224 may be transmitted or received over the network 1226 via the network interface device 1220. For example, the network interface device 1220 may communicate the instructions 1224 using any one or more transfer protocols (e.g., hypertext transfer protocol (HTTP)).

In some example embodiments, the machine 1200 may be a portable computing device, such as a smart phone or tablet computer, and have one or more additional input components 1230 (e.g., sensors or gauges). Examples of such input components 1230 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1224 for execution by the machine 1200, such that the instructions 1224, when executed by one or more processors of the machine 1200 (e.g., processor 1202), cause the machine 1200 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
identifying an A/B experiment of online content, the A/B experiment being targeted at actual members or potential members of an online social networking service (SNS);
accessing a first value of a metric associated with operation of the online SNS from a record of a database associated with an A/B testing system, the first value of the metric being generated as a result of a previous execution, by the A/B testing system, of the A/B experiment targeting a first segment of actual members or potential members;
generating, using one or more hardware processors associated with the A/B testing system, a predicted second value of the metric based on executing a prediction model associated with the A/B experiment, the executing of the prediction model targeting a second segment of members of potential members that is greater than the first segment;
determining that the predicted second value of the metric indicates an inferred negative impact of the A/B experiment on the metric; and
causing a display of an alert pertaining to the negative impact of the A/B experiment on the metric in a user interface displayed on a client device.

2. The method of claim 1, wherein the accessing of the first value of the metric includes:
selecting, from one or more values of one or more metrics generated as a result of the previous execution of the A/B experiment, the first value of the metric based on an indicator of a negative impact of the A/B experiment on the first value of the metric.

3. The method of claim 2, wherein the indicator of the negative impact of the A/B experiment on the first value of the metric includes a negative percentage value associated with the metric as a result of the previous execution of the A/B experiment.

4. The method of claim 2, wherein the indicator of the negative impact of the A/B experiment on the first value of the metric includes a positive percentage value associated with the metric as a result of the previous execution of the A/B experiment.

5. The method of claim 1, wherein the determining that the predicted second value of the metric indicates the inferred negative impact of the A/B experiment on the metric includes:
determining a negative impact value associated with the metric based on the first value of the metric and the predicted second value of the metric;
identifying an alert threshold value associated with the metric, the alert threshold value representing a particular value of the metric for which an alert pertaining to the A/B experiment negatively impacting the metric is issued; and
determining that the negative impact value associated with the metric exceeds the alert threshold value associated with the metric based on a comparison of the negative impact value and the alert threshold value.

6. The method of claim 1, further comprising:
generating the alert pertaining to the negative impact of the A/B experiment on the metric, the generating of the alert being based on the determining that the predicted second value of the metric indicates the inferred negative impact of the A/B experiment on the metric.

7. The method of claim 6, further comprising:
generating a communication for an owner of the metric, the communication including the alert pertaining to the negative impact of the A/B experiment on the metric; and
transmitting the communication to a client device associated with the owner of the metric.

8. The method of claim 1, wherein the second segment of members of potential members is represented by a ramp percentage value associated with a future execution of the A/B experiment, the method further comprising:
comparing the ramp percentage value and a ramp percentage threshold value associated with the metric;
determining that the ramp percentage value exceeds the ramp percentage threshold value; and
generating a further alert pertaining to the ramp percentage value exceeding the ramp percentage threshold value.

9. A system comprising:
a machine-readable medium for storing instructions that, when executed by one or more hardware processors, cause the one or more hardware processors to perform operations comprising:
identifying an A/B experiment of online content, the A/B experiment being targeted at actual members or potential members of an online social networking service (SNS);
accessing a first value of a metric associated with operation of the online SNS from a record of a database associated with an A/B testing system, the first value of the metric being generated as a result of a previous execution, by the A/B testing system, of the A/B experiment targeting a first segment of actual members or potential members;
generating, using one or more hardware processors associated with the A/B testing system, a predicted second value of the metric based on executing a prediction model associated with the A/B experiment, the executing of the prediction model targeting a second segment of members of potential members that is greater than the first segment;
determining that the predicted second value of the metric indicates an inferred negative impact of the A/B experiment on the metric; and
causing a display of an alert pertaining to the negative impact of the A/B experiment on the metric in a user interface displayed on a client device.

10. The system of claim 9, wherein the accessing of the first value of the metric includes:
selecting, from one or more values of one or more metrics generated as a result of the previous execution of the A/B experiment, the first value of the metric based on an indicator of a negative impact of the A/B experiment on the first value of the metric.

11. The system of claim 10, wherein the indicator of the negative impact of the A/B experiment on the first value of the metric includes a negative percentage value associated with the metric as a result of the previous execution of the A/B experiment.

12. The system of claim 10, wherein the indicator of the negative impact of the A/B experiment on the first value of the metric includes a positive percentage value associated with the metric as a result of the previous execution of the A/B experiment.

13. The system of claim 9, wherein the determining that the predicted second value of the metric indicates the inferred negative impact of the A/B experiment on the metric includes:
determining a negative impact value associated with the metric based on the first value of the metric and the predicted second value of the metric;
identifying an alert threshold value associated with the metric, the alert threshold value representing a particular value of the metric for which an alert pertaining to the A/B experiment negatively impacting the metric is issued; and
determining that the negative impact value associated with the metric exceeds the alert threshold value associated with the metric based on a comparison of the negative impact value and the alert threshold value.

14. The system of claim 9, wherein the operations further comprise:
generating the alert pertaining to the negative impact of the A/B experiment on the metric, the generating of the alert being based on the determining that the predicted second value of the metric indicates the inferred negative impact of the A/B experiment on the metric.

15. The system of claim 14, wherein the operations further comprise:
generating a communication for an owner of the metric, the communication including the alert pertaining to the negative impact of the A/B experiment on the metric; and
transmitting the communication to a client device associated with the owner of the metric.

16. The system of claim 9, wherein the second segment of members of potential members is represented by a ramp percentage value associated with a future execution of the A/B experiment, and wherein the operations further comprise:
comparing the ramp percentage value and a ramp percentage threshold value associated with the metric;
determining that the ramp percentage value exceeds the ramp percentage threshold value; and
generating a further alert pertaining to the ramp percentage value exceeding the ramp percentage threshold value.

17. A non-transitory machine-readable storage medium comprising instructions that, when executed by one or more processors of a machine, cause the machine to perform operations comprising:
identifying an A/B experiment of online content, the A/B experiment being targeted at actual members or potential members of an online social networking service (SNS);
accessing a first value of a metric associated with operation of the online SNS from a record of a database associated with an A/B testing system, the first value of the metric being generated as a result of a previous execution, by the A/B testing system, of the A/B experiment targeting a first segment of actual members or potential members;
generating, using one or more hardware processors associated with the A/B testing system, a predicted second value of the metric based on executing a prediction model associated with the A/B experiment, the executing of the prediction model targeting a second segment of members of potential members that is greater than the first segment;
determining that the predicted second value of the metric indicates an inferred negative impact of the A/B experiment on the metric; and
causing a display of an alert pertaining to the negative impact of the A/B experiment on the metric in a user interface displayed on a client device.

18. The non-transitory machine-readable storage medium of claim 17, wherein the accessing of the first value of the metric includes:
selecting, from one or more values of one or more metrics generated as a result of the previous execution of the A/B experiment, the first value of the metric based on an indicator of a negative impact of the A/B experiment on the first value of the metric.

19. The non-transitory machine-readable storage medium of claim 17, wherein the determining that the predicted second value of the metric indicates the inferred negative impact of the A/B experiment on the metric includes:
determining a negative impact value associated with the metric based on the first value of the metric and the predicted second value of the metric;
identifying an alert threshold value associated with the metric, the alert threshold value representing a particular value of the metric for which an alert pertaining to the A/B experiment negatively impacting the metric is issued; and
determining that the negative impact value associated with the metric exceeds the alert threshold value associated with the metric based on a comparison of the negative impact value and the alert threshold value.

20. The non-transitory machine-readable storage medium of claim 17, wherein the second segment of members of potential members is represented by a ramp percentage value associated with a future execution of the A/B experiment, and wherein the operations further comprise:
comparing the ramp percentage value and a ramp percentage threshold value associated with the metric;
determining that the ramp percentage value exceeds the ramp percentage threshold value; and
generating a further alert pertaining to the ramp percentage value exceeding the ramp percentage threshold value.
